(19) United States
(12) Patent Application Publication
(10) Pub. No.: US 2009/0226606 A1
(43) Pub. Date: Sep. 10, 2009

(54) MANUFACTURING METHOD OF A PERPENDICULAR MAGNETIC RECORDING MEDIUM

(75) Inventor: Ryosaku Inamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/273,956

(22) Filed: Nov. 19, 2008

(30) Foreign Application Priority Data
Mar. 5, 2008 (JP) 2008-055271

(51) Int. Cl. B05D 5/00

(52) U.S. Cl. 427/131

(57) ABSTRACT

In a manufacturing method of a perpendicular magnetic recording medium, a lower base layer is formed by depositing Ru or an Ru alloy on a soft magnetic underlayer in an inert gas atmosphere containing carbonized oxygen. An upper base layer is formed by depositing Ru or an Ru alloy on the lower base layer in an inert gas atmosphere. A magnetic layer serving as a recording layer is formed on the upper base layer.

### CROSS-REFERENCE TO RELATED APPLICATIONS

This application is based upon and claims the benefit of priority of the prior Japanese Patent Application No. 2008-055271, filed on Mar. 5, 2008, the entire contents of which are incorporated herein by reference.

### FIELD

The embodiment discussed herein is directed to a manufacturing method of a perpendicular magnetic recording medium.

### BACKGROUND

A hard disk drive unit serves as a digital signal recording apparatus, which has a low unit cost of memory per one bit and used as a mass storage memory. In recent years, many hard disk drive units have been used in electronic equipments such as, for example, a personal computer. Further, in association with entering the age of ubiquitous, a demand for the hard disk drive unit as a recording apparatus is expected to be increased dramatically with use in digital audio and video equipments playing a role of an engine. Accordingly, in order to record video signals, a further increase in the storage capacity of the hard disk drive unit is required.

A hard disk drive unit is built into a product for home use in many cases. Thus, in addition to such an increase in the storage capacity, it is necessary to reduce a unit cost of memory. In this regard, reducing a number of parts constituting a hard disk drive unit is an effective way to reduce the unit cost. Specifically, it is possible to increase a storage capacity without increasing a necessary number of magnetic recording media (magnetic disks) by attempting a high recording density of the magnetic recording media (magnetic disks). Further, if a dramatic increase in the recording density is realized, it may be possible to reduce a number of magnetic recording media while increasing a storage capacity, which may reduce a number of magnetic heads used. As a result, a unit cost of memory can be dramatically increased.

Under the above-mentioned circumstances, achieving a high density recording of magnetic recording media has become a very important issue. Specifically, it is an important issue to achieve a higher SN ratio (ratio of noise to output) based on a high resolution (high output) and a low noise. In order to achieve such an improvement in recording density, it is attempted to miniaturize and uniformize the magnetic grains constituting a magnetic recording layer and to isolate each of the magnetic grains.

In the meantime, in a conventional manufacturing process of a perpendicular magnetic recording medium, a CoCr based alloy film is formed by a sputter method using substrate heating so as to produce a magnetic recording layer. In such a CoCr based alloy film, magnetic isolation of magnetic grains is attempted by causing non-magnetic Cr to segregate in a grain boundary of the magnetic grains in the CoCr based alloy. However, in order to suppress generation of a spike noise caused by formation of magnetic domains, it is necessary to arrange an amorphous soft magnetic layer in a lower layer part. In order to maintain the soft magnetic layer to be amorphous, a problem has occurred in that a substrate heating process necessary for Cr segregation cannot be carried out when forming the magnetic layer.

In order to solve such a problem, a perpendicular magnetic recording medium has been developed, in which a magnetic film formed of a CoCr based alloy with SiO₂ added thereto is used as a magnetic recording layer instead of a Cr segregation technique using a heating process. In such a magnetic film, CoCr based alloy magnetic grains (for example, CoCrPt) are spatially isolated from each other by an oxide material (for example, SiO₂), which is a non-magnetic material so as to achieve magnetic isolation of crystal grains.

In order to form the magnetic recording layer of a structure (granular structure) in which magnetic grains are surrounded by a non-magnetic material such as SiO₂, a thick ruthenium (Ru) film may be arranged in the form of a continuous film under the magnetic recording layer. In the thick Ru film, a groove shape having an appropriate depth is formed in an Ru crystal grain boundary part so as to form a magnetic recording layer having a structure in which the magnetic crystal grains formed on the Ru crystal grains are spatially isolated from each other by SiO₂.

However, if the film thickness of the Ru base layer inserted between the magnetic recording layer and the underlayer is large, a magnetizing force of a write head necessary for writing must be large, which may generate write exudation. Additionally, if the film thickness of the Ru base film is increased, a crystal grain size is increased.

In order to solve such a problem, there is suggested a method of causing an Ru base layer 15 used as a base of a recording layer 16, which is a magnetic film, to have a gap structure in which Ru crystal grains 15a are spatially isolated from each other by gap parts 15b, as shown in FIG. 1 (for example, refer to Patent Document 1).

In the example shown in FIG. 1, a soft magnetic underlayer 12 and an orientation control layer 13 are arranged on a substrate 11. Then, a first base layer (lower base layer) 14, which is a continuous film, and a second base layer (upper base layer) 15 having a gap structure are arranged on the orientation control layer 13. A granular magnetic layer 16 as a recording layer is provided on the second base layer 15. A write auxiliary layer 17 is provided on the granular magnetic layer 16, and the write auxiliary layer 17 is covered by a protective layer 18. A lubricant is applied on the protective layer 18 so as to form a lubricant layer 19. By causing the second base layer 15 to have the gap structure in which the gap parts 15b are provided between the crystal grains 15a, the crystal grain structure in the second base layer 15 is succeeded by the granular magnetic layer 16 above the second base layer 15. Thus, it is possible to form a structure in which an oxide material 16b, which is a non-magnetic material, is filled between the magnetic crystal grains 16a while uniformizing the grain size of the magnetic crystal grains 16a of the granular magnetic layer 16.

Patent Document: Japanese Laid-Open Patent Application No. 2005-353256

By forming the second base layer 15, which consists of crystal grains of ruthenium (Ru) like the example illustrated in FIG. 1, the magnetic crystal grains 16a of the granular magnetic layer 16 can be caused to grow up on the Ru crystal grains 15a, which results in formation of the isolated minute magnetic crystal grains 16a. Thereby, a recording density can be increased, and an amount of recording per unit volume can be increased.

As mentioned above, the second base layer 15 is provided to promote isolation of the magnetic crystal grains of the granular magnetic layer 16 and to control the crystal orientation. In order to promote isolation of each magnetic crystal grain, it is necessary to form appropriate unevenness on the surface of the second base layer 15. For this reason, the second base layer 15 is formed by isolated Ru crystal grains 15a. In order to form such an Ru film consisting of Ru crystal grains by a deposition method using sputtering, Ru is sputtered and deposited at a low deposition rate under a relatively high pressure. That is, the second base layer 15 needs to be deposited by sputtering Ru at a low deposition rate under a high pressure.

On the other hand, in order to arrange the C axis, which is a magnetization easy axis of the magnetic crystal grains 16a of the granular magnetic layer 16, in a direction perpendicular to the substrate surface, it is also necessary to arrange the C axis of the middle layer in a direction almost perpendicular to the substrate surface. In order to form an Ru film having such a structure by the deposition method using sputtering, it is necessary to deposit Ru by sputtering at a high deposition rate under a relatively low pressure. Thus, a first base layer 14 is provided under the second base layer 15.

That is, the Ru base layer has a double layer structure in which the first base layer 14 is formed by depositing Ru at a high deposition rate under a low pressure, and, then, the second base layer 15 is provided on the first base layer 14 by depositing Ru at a low deposition rate under a high pressure. Thereby, isolation of the magnetic crystal grains 16a of the granular magnetic layer 16 is promoted, and the C axis, which is a magnetization easy axis of each magnetic crystal grain 16a is arranged in a direction perpendicular to the substrate surface.

The above-mentioned Ru base layer having a double layer structure is formed under a film deposition condition in an experimental laboratory, and it has been found that such a film deposition condition in an experimental laboratory cannot be reproduced in an actual mass-production process. For example, in an actual mass-production process, the size of the crystal grains of the first base layer 14, which is deposited under a low pressure, tends to be large, and, as a result, the size of the magnetic crystal grains 16a of the granular magnetic layer 16, which is deposited on the first base layer 14, becomes large. Therefore, in an actual mass-production process, the desired minute magnetic crystal grains 16a may not be obtained.

Thus, it is desired to develop a technique to produce minute magnetic crystal grains of a granular magnetic layer serving as a recording layer by reducing a size of crystal grains of a first base layer in an Ru base layer having a double layer structure.

### SUMMARY

There is provided a manufacturing method of a perpendicular magnetic recording medium, including: forming a lower base layer by depositing Ru or an Ru alloy on a soft magnetic underlayer in an inert gas atmosphere containing carbonized oxygen; forming an upper base layer by depositing Ru or an Ru alloy on the lower base layer in an inert gas atmosphere; and forming a magnetic layer on the upper base layer.

Additional objects and advantages of the embodiment will be set forth in part in the description which follows, and in part will be obvious from the description, or may be learned by practice of the invention. The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1 is a cross-sectional view of a perpendicular magnetic recording medium;

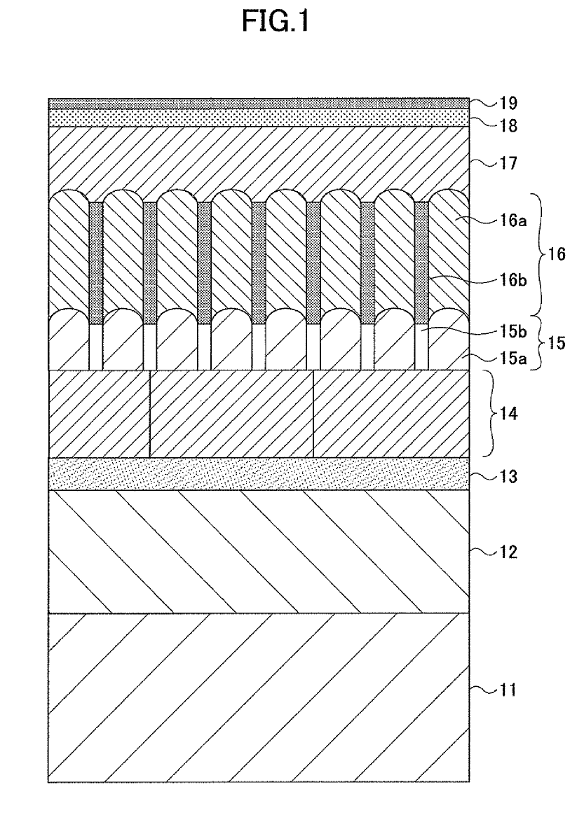

FIG. 2 is a cross-sectional view of a perpendicular magnetic recording medium produced by a manufacturing method according to an embodiment;

FIG. 3 is a graph indicating a result of measurement of cumulative square error (VMM);

FIG. 4 is a graph indicating a result of measurement of an effective write core width (WCw); and

FIG. 5 is a graph indicating a result of measurement of a coercive force (Hc).

### DESCRIPTION OF EMBODIMENT(S)

Preferred embodiment of the present invention will be explained with reference to the accompanying drawings.

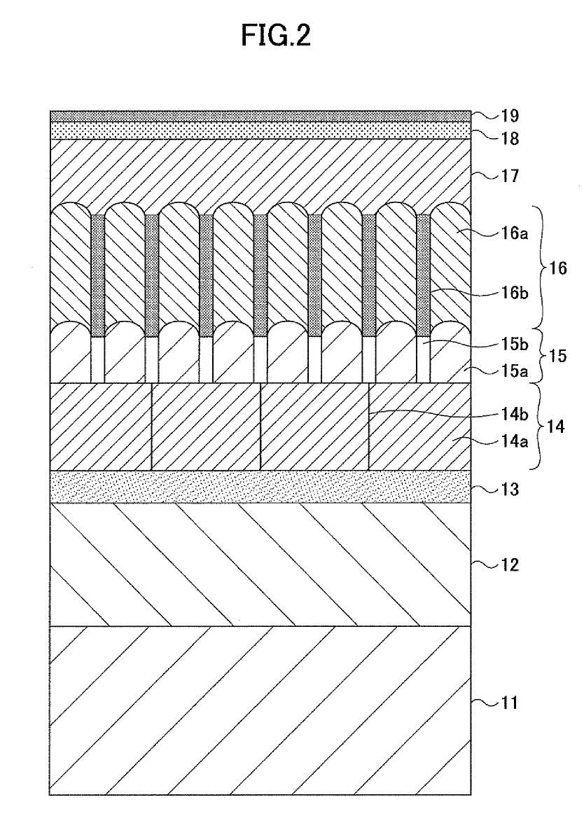

FIG. 2 is a cross-sectional view of a perpendicular magnetic recording medium produced by a manufacturing method according to an embodiment.

The perpendicular magnetic recording medium 10 has a structure in which a soft magnetic underlayer (SUL) 12, an orientation control layer 13, a first base layer (lower base layer) 14, a second base layer (upper base layer) 15, a granular magnetic layer 16 serving as a recording layer, a write-in auxiliary layer 17, a protective layer 18 and a lubricant layer 19 are formed sequentially on a substrate 11.

The substrate 11 is an arbitrary substrate, which can be used as a base board of a magnetic recording medium, such as a plastic substrate, a glass substrate, an Si substrate, a ceramics substrate, a heat-resistant plastic substrate, etc. In the present embodiment, a glass disk substrate is used as the substrate 11.

The soft magnetic underlayer 12 is formed of an arbitrary soft magnetic material of amorphous or minute crystal, and a thickness thereof is about 10 nm to 400 nm. The soft magnetic underlayer 12 may have a single layer structure or a laminated structure. The soft magnetic underlayer 12 is for absorbing magnetic fluxes from a recording head, and a product of a saturation magnetic-flux density Bs and a film thickness is preferably large. As a soft magnetic material having a saturation magnetic-flux density Bs of 1.0 T or larger, it is preferable to use FeSi, FeAlSi, FeTaC, CoZrNb, CoCrNb, NiFeNb, Co, etc. On the other hand, from the viewpoint of mass-production nature, the film thickness of the soft magnetic underlayer 12 is thinner the better. From the viewpoint of a balance of the write-in characteristic and the mass-production nature, the soft magnetic underlayer 12 preferably has a thickness of 20 μm to 100 μm.

The film thickness of the orientation control layer 13 is about 1.0 nm to about 10 nm. The orientation control layer 13 has a function to orient the C axis (easy magnetization axis) of the crystal grains of the first and second base layers 14 and 15 formed thereon in a direction of the thickness and to distribute the crystal grains of the first and second base layers 14 and 15 uniformly in an in-plane direction. The orientation control layer 13 is formed of Ta, Ti, C, Mo, W, Re, Os, Hf, amorphous Mg and amorphous Pt, and at least one material selected from alloys of the aforementioned. The film thickness of the orientation control layer 13 is preferably set in a range of 2.0 nm-5.0 nm from the viewpoint of the necessity of arranging the soft magnetic underlayer 12 and the recording layer 16 close to each other and acquisition of a control function of crystal orientation of an upper layer.

The first base layer 14, which is a lower base layer formed on the orientation control layer 13, is formed as a continuous polycrystalline film of ruthenium (Ru) or an Ru alloy having a hexagonal close-packed (hcp) crystal structure, and contains crystal grains 14a and crystal boundaries 14b. The second base layer 15, which is an upper base layer, is a continuous polycrystalline film in which crystal grains 15a are coupled with each other through crystal boundaries 15b, and has excellent crystallinity. The crystal orientation of the (001) plane of the second base layer 15 is perpendicular to the substrate 11. It is desirous to arrange the first base layer 14 directly under the second base layer 15 so as to improve crystallinity and orientation of the second base layer 15 and the granular magnetic layer 16.

Although the first base layer 14 is formed after the orientation control layer 13 is formed on the soft magnetic underlayer 12 in the present embodiment, the orientation control layer 13 is not necessarily provided, and the first base layer 14 may be formed directly on the soft magnetic underlayer 12.

It should be noted that, in the perpendicular magnetic recording medium according to the present embodiment, the size of the crystal grains of the first base layer 14 is smaller than crystal grains of a first base layer formed by a conventional manufacturing method.

The second base layer 15 is formed on the first base layer 14. The second base layer 15 contains the crystal grains 15a extending in a direction perpendicular to the substrate 11 and a gap part 15b which isolates the crystal grains 15a from each other.

In the present embodiment, the granular magnetic layer 16 is formed as a recording layer on the second base layer 15. The film thickness of the granular magnetic layer 16 is, for example, 6 nm to 20 nm. The granular magnetic layer 16 contains pillar-shaped magnetic crystal grains 16a extending in a direction perpendicular to the substrate 11 and non-magnetic material 16b surrounding each of the magnetic crystal grains 16a and isolate the magnetic crystal grains 16a from each other in an in-plane direction. The magnetic crystal grains 16a grow up on the respective crystal grains 15a of the second base layer 15 under the granular magnetic layer 16.

Magnetic recording is performed by magnetizing the magnetic crystal grains 16a perpendicularly to the substrate surface. In order to obtain a recording medium of a large capacity by increasing the recording density, it is desirable that the average grain size of the magnetic crystal grains 16a is equal to or greater than 2 nm and equal to or smaller than 10 nm.

As a material of the magnetic crystal grains 16a, it is desirous to use a ferromagnetic material having a hcp crystal structure, which may be a Co alloy such as CoCr, CoCrTa, CoPt, CoCrPt, and CoCrPt-M. As for the non-magnetic material 16b, an arbitrary non-magnetic material may be used, which does not dissolve with magnetic crystal grains 16a, or does not form a compound. As such a non-magnetic material, an oxide such as SiO₂, Al₂O₃, Ta₂O₅, etc., a nitride such as Si₃N₄, and AlN, TaN, etc., and a carbide such as SiC, TaC, etc., may be used. Although a single layer consisting of the magnetic crystal grains 16a and the non-magnetic material 16b surrounding the magnetic crystal grains 16a is illustrated in FIG. 2, a multi-layer structure containing at least one layer having such a structure may be used, or the single layer structure may be used.

The write-in auxiliary layer 17 is, for example, a CoCrPt magnetic film or a CoCrB magnetic film. The write-in auxiliary layer 17 has a function to assist and improve the magnetization of the magnetic crystal grains 16a. The protective layer 18 is formed of a carbon thin film or the like, and has a function to cover and protect the write-in auxiliary layer 17. The lubricant layer 19 is provided by applying a lubricant to the write-in auxiliary layer 17.

As mentioned above, in the perpendicular magnetic recording medium according to the present embodiment, the size of the crystal grains 14a of the first base layer 14 is smaller than crystal grains of a first base layer formed by a conventional manufacturing method. Thereby, the size of the magnetic crystal grains 16a of the granular magnetic layer 16 formed above the crystal grain 14a of the first based layer 14 can also be made smaller than magnetic crystal grains of a granular magnetic layer formed by a conventional manufacturing method.

A description will be given below of an example of a manufacturing process of the above-mentioned perpendicular magnetic recording medium.

First, the surface of the substrate 11 is cleaned and dried, and, thereafter, a CoZrNb film of a film thickness of 200 nm is formed as the soft magnetic underlayer 12 on the substrate 11 Then, for example, a single layer Ta film having a film thickness of 3 nm is formed as the orientation control layer 13. It is desirable to form each of the CoZrNb film and the Ta film by using a DC sputter method in an argon (Ar) gas atmosphere. In this case, it is desirable to set a film deposition pressure to about 0.5 Pa and set a film deposition temperature to a room temperature.

Then, the first base layer 14, which consists of Ru or an Ru alloy, is formed on the orientation control layer 13 with a film thickness of, for example, 14 nm by a room temperature deposition according to a DC sputter method under an inert gas atmosphere of a relatively low pressure (about 0.7 Pa). It is preferable to use an argon (Ar) gas as an inert gas. Other than the Ar gas, an inert gas such as krypton or xenon may be used. In the present embodiment, when the first base layer 14 serving as a lower base layer is formed, carbonized oxygen is added to the Ar gas. Although carbon dioxide is used as the carbonized oxygen in the present embodiment, other carbonized oxygen such as, for example, carbon monoxide (CO) may be used. The carbon dioxide content at the time of adding the carbon dioxide as carbonized oxygen to the Ar gas is preferably equal to or greater than 2% and equal to or smaller tan 10%.

The first base layer 14, in which small crystal grains 14a continuously exist, can be formed by setting the pressure of the inert gas atmosphere, which is an Ar gas added with carbon dioxide (CO₂) as carbonized oxygen, to be equal to or lower than 2.0, more preferably, to be equal to 0.7 Pa.

Then, the second base layer 15 serving as an upper layer is formed with a film thickness of, for example, about 7.5 nm by a room temperature deposition according to a DC sputter method under an Ar gas pressure of a relatively high pressure (about 5 Pa). The second base layer 15 can be made into a gap structure by controlling the deposition rate under a high pressure (5 Pa). The deposition rate of the second base layer 15 is preferably set to 1.0 to 2.0 nm/sec. The second base layer 15 having an excellent gap structure can be formed by depositing Ru or an Ru alloy having a film thickness of 7.5 nm by a room temperature deposition according to a DC sputter method at a deposition rate of 1.0 to 2.0 nm/sec under an Ar gas atmosphere of 5.0 Pa.

Then, a CoCrPt—SiO2 film of a film thickness of 10 nm is formed as the granular magnetic layer 16 serving as a recording layer by a room temperature deposition according a DC sputter method under an Ar gas pressure of 3.0 Pa to 6.0 Pa. More specifically, the CoCrPt crystal grains 16a having an easy axis in a direction perpendicular to the substrate 11 and the SiO₂ as the non-magnetic material 16b are formed at a deposition rate of, for example, 0.5 nm/sec.

Then, a CoCrPt magnetic film of a film thickness of, for example, 5 nm is formed as the write-in auxiliary layer 17 by a room temperature deposition according to a DC sputter method at a deposition rate of 0.5 nm/sec under an Ar gas pressure of about 0.5 Pa. In the above-mentioned series of film deposition processes, a vacuum atmosphere is maintained consistently.

Finally, a carbon film is formed as the protective layer 18 on the write-in auxiliary layer 17, and a lubricant is applied to the protective layer 18 so as to form the lubricant layer 19.

As mentioned above, in the present embodiment, the size of the crystal grains 14a of the first base layer 14 (lower base layer) is reduced to be smaller than the size of crystal grains of a conventional lower base layer by adding carbon dioxide (CO₂) to the Ar gas atmosphere when forming the first base layer 14 (lower base layer). Because the size of the crystal grains 14a depends on an amount of carbon dioxide added to the Ar gas atmosphere, samples were produced in which the first base layer 14 (lower base layer) is formed by varying an added amount of carbon dioxide, and a magnetic characteristic and a read/write characteristic were measured.

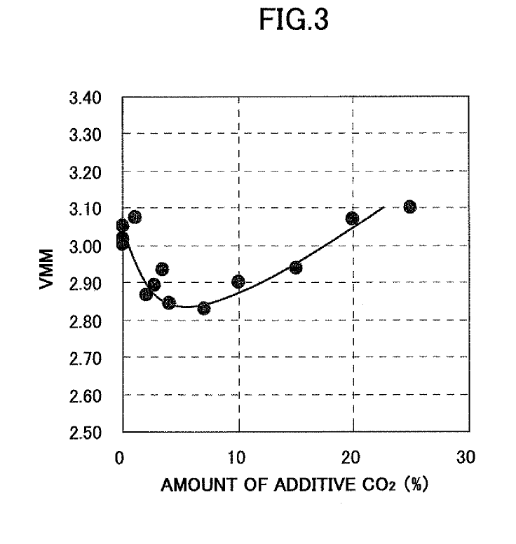

The graph of FIG. 3 indicates a result of measurement of a cumulative square error (VMM) corresponding to an inverse number of an error rate as a read characteristic. In the graph of FIG. 3, the horizontal axis represents an added amount of carbon dioxide (CO₂) added to the Ar gas, and the vertical axis represents VMM.

It can be appreciated from the graph of FIG. 3 that VMM decreases to a point at which the added amount of carbon dioxide is about 20% if carbon dioxide (CO₂) is added to the Ar gas atmosphere when forming the first base layer 14 serving as a lower base layer by sputter of Ru or an Ru alloy. Additionally, it can be appreciated that VMM is minimized at a point at which the added amount of carbon dioxide is about 6%, and VMM is maintained at a low value close to the minimum value in a range of 2% to 10%. Since VMM is a value corresponding to an inverse number of an error rate, a good magnetic characteristic having less reading error can be obtained as VMM is decreased.

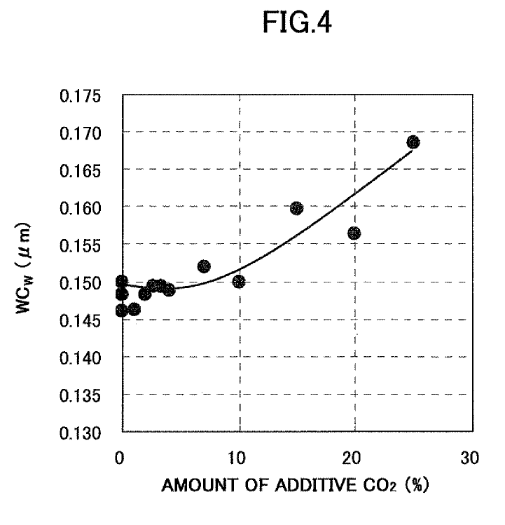

The graph of FIG. 4 indicates a result of measurement of an effective write core width (WCw) as a write characteristic. In the graph of FIG. 4, the horizontal axis represents an amount of corbon dioxide (CO₂) added to the Ar gas, and the vertical axis represents an effective write core width (WCw).

It can be appreciated from the graph of FIG. 4 that the effective write core width (WCw) increases as the added amount of carbon dioxide increases when carbon dioxide is added to the Ar gas atmosphere. Because a write width can be smaller as the effective write core width (WCw) is narrower, a recording density can be increased by setting the effective write core width (WCw) smaller. In this viewpoint, it is not desirable to add carbon dioxide (CO₂) to the Ar gas atmosphere, but it can be appreciated from the graph of FIG. 4 that if the added amount of carbon dioxide does not exceed 10%, there is no large change (increase) in the effective write core width (WCw). That is, if the added amount of carbon dioxide does not exceed 10%, there is little influence given to the effective write core width (WCw) even if carbon dioxide is added.

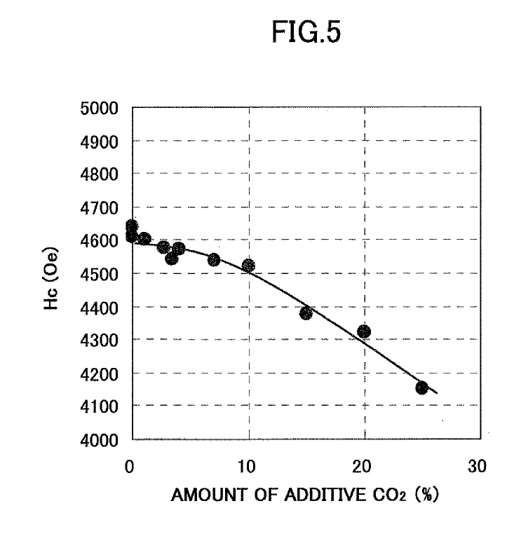

Next, a relationship between an amount of addition of carbon dioxide to Ar gas and a coercive force (Hc) of the perpendicular magnetic recording medium was investigated. FIG. 5 is a graph indicating a relationship between the amount of addition of carbon dioxide to Ar gas and coercive force (Hc) of a perpendicular magnetic recording medium. In the graph of FIG. 5, the horizontal axis represents an amount of addition of carbon dioxide added to Ar gas, and the vertical axis represents a coercive force (Hc) of the recording layer.

According to the graph of FIG. 5, it is appreciated that when carbon dioxide (CO₂) was added to the Ar gas atmosphere, the coercive force (Hc) of the recording layer decreases as an amount of addition of carbon dioxide increased. A more stable magnetic recording can be performed as the coercive force (Hc) increases. Thus, it is better to set the coercive force (Hc) as large as possible. In this viewpoint, it is not desirable to add carbon dioxide (CO₂) to the Ar gas atmosphere. However, it can be appreciated from the graph of FIG. 5 that if an amount of carbon dioxide added to the Ar gas atmosphere does not exceed 10%, the effective write core width (WCw) is reduced slightly and there is no large change (decrease) in the effective write core width (WCw). That is, if an amount of addition of carbon dioxide is equal to or smaller than 10%, there is little influence to the coercive-force (Hc) of the recording layer even when carbon dioxide is added.

Here, it is considered that the reason for a decrease in the coercive force (Hc) when carbon dioxide (CO₂) is added to the Ar gas atmosphere is that the size of the magnetic crystal grains 16a of the granular magnetic layer 16 serving as a recording layer is reduced. That is, it is considered that since the size of magnetic crystal grains 16a is reduced, the magnetic domains become small, which results in the coercive force (Hc) being reduced because it is affected by a heat energy caused by application of a magnetic field. The size of the magnetic crystal grains 16a of the granular magnetic layer 16 is determined by the size of the crystal grains 15a of the second base layer 15 situated under the granular magnetic layer 16. Moreover, the size of the crystal grains 15a is determined by the size of the crystal grains 14a of the first base layer 14 situated under the second base layer 15. Therefore, it can be presumed that the reason for the size of magnetic crystal grains 16a of the granular magnetic layer 16 being reduced is because carbon dioxide (CO₂) is added to the Ar gas atmosphere when forming the first base layer 14.

As mentioned above, according to the measurement results indicated in the graphs of FIG. 3 through FIG. 5, it can be appreciated that by setting the amount of addition of carbon dioxide (CO₂) to the Ar gas, i.e., the content of carbon dioxide (CO₂) in the Ar gas, to be equal to or greater than 2% and equal to or smaller than 10%, the size of the crystal grains 14a of the first base layer 14 (lower base layer) is reduced, and, consequently, the magnetic characteristic and the read/write characteristic is improved.

All examples and conditional language recited herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A manufacturing method of a perpendicular magnetic recording medium, comprising:
forming a lower base layer by depositing Ru or an Ru alloy on a soft magnetic underlayer in an inert gas atmosphere containing carbonized oxygen;
forming an upper base layer by depositing Ru or an Ru alloy on the lower base layer in an inert gas atmosphere; and
forming a magnetic layer on the upper base layer.

2. The manufacturing method according to claim 1, wherein the forming the lower base layer includes setting an amount of the carbonized oxygen added to the inert gas atmosphere to be equal to or greater than 2% and to be equal to or smaller than 10%.

3. The manufacturing method according to claim 1, wherein argon is use as an inert gas to create the inert gas atmosphere.

4. The manufacturing method according to claim 3, wherein when forming the lower base layer, carbon dioxide is used as the carbonized oxide.

5. The manufacturing method according to claim 4, wherein when forming the lower base layer, a pressure of the inert gas atmosphere containing argon and carbon dioxide is set to 0.7 Pa and a deposition rate is set to 3 to 5 nm/sec.

6. The manufacturing method according to claim 4, wherein when forming the upper base layer, a pressure of the inert gas atmosphere containing argon is set to 5.0 Pa and a deposition rate is set to 1 to 2 nm/sec.
